(19) United States
(12) Patent Application Publication
(10) Pub. No.: US 2021/0120976 A1
(43) Pub. Date: Apr. 29, 2021

(54) SENSORY DISPLAY

(71) Applicant: Visual Elements Manufacturing Inc., Woodbridge (CA)

(72) Inventor: Aaron B. Willinsky, Woodbridge (CA)

(21) Appl. No.: 17/063,436

(22) Filed: Oct. 5, 2020

Related U.S. Application Data
(60) Provisional application No. 62/910,909, filed on Oct. 4, 2019.

(51) Int. Cl. A47F 3/00; A47F 3/10; A47F 7/00

(52) U.S. Cl. CPC A47F 3/005; A47F 7/0078; A47F 3/10; A47F 3/001

(57) ABSTRACT

Described herein is a sensory display comprising a rotatable body for enclosing a product. Also described herein is a display comprising a scent valve for smelling an enclosed product.

### FIELD

The present invention relates to displays. More specifically, the present invention is, in aspects, concerned with sensory displays and related methods.

### BACKGROUND

U.S. Pat. No. 10,384,834 describes containers for displaying, visualizing, and aroma sampling botanical materials—such as tea, Cannabis, and the like including a container body, lid, and lens—which may have various shapes. In a preferred embodiment, the lid is shaped to define a recessed area with scent openings permitting aroma sampling of a sample contained within. A removable plug is shaped to fit within the recessed area of the lid. The container body and lid, with the removable plug fit within the lid, and form an airtight chamber within. A botanical sample may be visualized through the lens.

### SUMMARY

In accordance with an aspect, there is provided a sensory display comprising a rotatable body for enclosing a product.

In an aspect, the product is isolated from being touched by a user.

In an aspect, the body comprises a scent port for smelling the product.

In an aspect, the scent port comprises a screen, optionally of fine mesh.

In an aspect, the scent port comprises a scent valve.

In an aspect, the scent valve is a gravity valve or a squeeze valve squeezable from a closed position to an open position, wherein the squeeze valve is biased to the closed position.

In an aspect, the closed position is substantially airtight.

In an aspect, the scent valve comprises silicone.

In an aspect, the display comprises at least one region of transparency in the body for viewing the product, wherein the at least one region of transparency optionally magnifies the product.

In an aspect, the body is substantially cylindrical and comprises a circumferential wall, the circumferential wall comprising a first end and a second end defining an interior space therebetween.

In an aspect, the display further comprises a first cover for enclosing the first end of the circumferential wall.

In an aspect, the first cover comprises a first window that optionally magnifies the product.

In an aspect, the first cover and first end of the cylindrical body are threaded for screwing the first cover onto the first end of the circumferential wall.

In an aspect, the first cover and first end of the cylindrical body are smooth for sliding the first cover onto the first end of the circumferential wall.

In an aspect, the display further comprises a second cover for enclosing the second end of the circumferential wall.

In an aspect, the second cover comprises a second window that optionally magnifies the product.

In an aspect, the second cover and second end of the circumferential wall are threaded for screwing the second cover onto the second end of the circumferential wall.

In an aspect, the second cover and second end of the cylindrical body are smooth for sliding the second cover onto the second end of the circumferential wall.

In an aspect, the first and/or second cover lockably engages the respective first and or second end of the circumferential wall.

In an aspect, the display further comprises one or more keys for engaging with and removing the first and/or second cover.

In an aspect, the key comprises one or more protrusions that engage with indentations on the first and/or second cover.

In an aspect, the circumferential wall comprises an inner wall and an outer wall.

In an aspect, the inner wall is spaced from the outer wall defining a gap between the inner and outer walls.

In an aspect, the scent valve extends through the outer wall and comprises a flange disposed between the inner and outer walls to hold the scent valve in position.

In an aspect, the inner wall comprises one or more apertures providing fluid communication between the gap and the interior space.

In an aspect, the display comprises a moisture-controlling component such as a moisture pack in the gap.

In an aspect, the display further comprises a knuckle for supporting the body for rotation.

In an aspect, the knuckle comprises an inner knuckle and an outer knuckle, rotatably engaged to one another.

In an aspect, the display further comprises an arm for supporting the body on a surface, such as a table or wall.

In an aspect, the body is cantilevered with respect to the arm.

In an aspect, the body comprises an interior support for mounting the product.

In an aspect, the support remains stationary when the body is rotated.

In an aspect, the support rotates together with or independently of the body.

In an aspect, the support extends through the circumferential wall and engages the knuckle.

In an aspect, the support comprises a clip.

In an aspect, the body protects the product from tampering and/or theft.

In an aspect, the body provides a controlled environment for the product.

In an aspect, the body provides a humidity controlled environment for the product.

In an aspect, the body rotates about a central axis.

In an aspect, the body is weighted and/or supported so as automatically to return to a desired position after rotation.

In accordance with an aspect, there is provided a display comprising a scent valve for smelling an enclosed product.

In an aspect, the scent valve is a gravity valve or a squeeze valve squeezable from a closed position to an open position, wherein the squeeze valve is biased to the closed position.

In an aspect, the closed position is substantially airtight.

In an aspect, the scent valve comprises a screen.

In an aspect, the scent valve comprises silicone.

In an aspect, the display further comprises the product.

In an aspect, the product is a product of value.

In an aspect, the product is aromatic.

In an aspect, the product comprises a plant product, such as an herb or spice.

In an aspect, the product comprises Cannabis and/or hemp.

In an aspect, the product comprises jewelry, such as a ring and/or earrings.

In an aspect, the display further comprises the product.

In an aspect, the display further comprises a display screen.

In accordance with an aspect, there is provided a plurality of the displays described herein.

Other features and advantages of the present invention will become apparent from the following detailed description. It should be understood, however, that the detailed description and the specific examples while indicating aspects of the invention are given by way of illustration only, since various changes and modifications within the spirit and scope of the invention will become apparent to those skilled in the art from said detailed description.

### DESCRIPTION OF THE FIGURES

The present invention will be further understood from the following description with reference to the Figures, in which:

FIG. 1 shows a perspective view of a display as described herein;

FIG. 2 shows another perspective view of the display of FIG. 1;

FIG. 3 shows another perspective view of the display of FIG. 1;

FIG. 4 shows another perspective view of the display of FIG. 1;

FIG. 5 shows another perspective view of the display of FIG. 1;

FIG. 6 shows side, front, and top views of the display of FIG. 1;

FIG. 7 shows an exploded view of the display of FIG. 1;

FIG. 8 shows another exploded view of the display of FIG. 1;

FIG. 9 shows another exploded view of the display of FIG. 1;

FIG. 10 shows a cross-sectional view of the display of FIG. 1, taken along cross-section line A-A of FIG. 6;

FIG. 11 shows another cross-sectional view of the display of FIG. 1, taken along cross-section line B-B of FIG. 6;

FIG. 12 shows a perspective view of a plurality of displays of FIG. 1 mounted on a wall;

FIG. 13 shows a closer view of the plurality of displays of FIG. 12;

FIG. 14 shows a perspective view of a plurality of displays of FIG. 1 mounted on a table;

FIG. 15 shows a perspective view of another embodiment of the display described herein.

### DETAILED DESCRIPTION

### Definitions

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” (or vice versa) wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein.

It will be understood that any component defined herein as being included may be explicitly excluded from the claimed invention by way of proviso or negative limitation, whether implicitly or explicitly defined herein. In addition, all ranges given herein include the end of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### Display

Described herein are sensory displays that isolate a product from direct manipulation by a user. The displays are suitable for holding any type of product but are typically used for products of high relative value and/or products that are sold under restrictions to the public. Examples include expensive jewelry, electronics, herbs, spices, plant matter, including Cannabis and/or hemp, coffee, tea, tobacco, and so on. In typical aspects, the display is for use with an aromatic product, whereby scent of the product may be of importance in a user's decision for purchasing the product. In alternate or additional typical aspects, the display is for use with a product that benefits from magnified visual inspection.

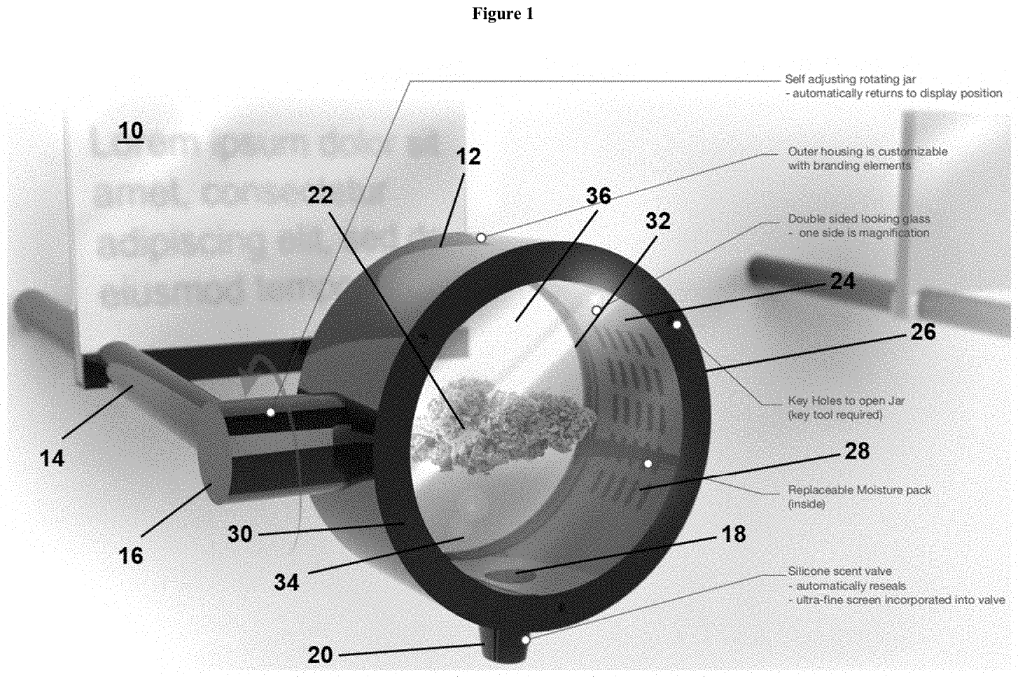

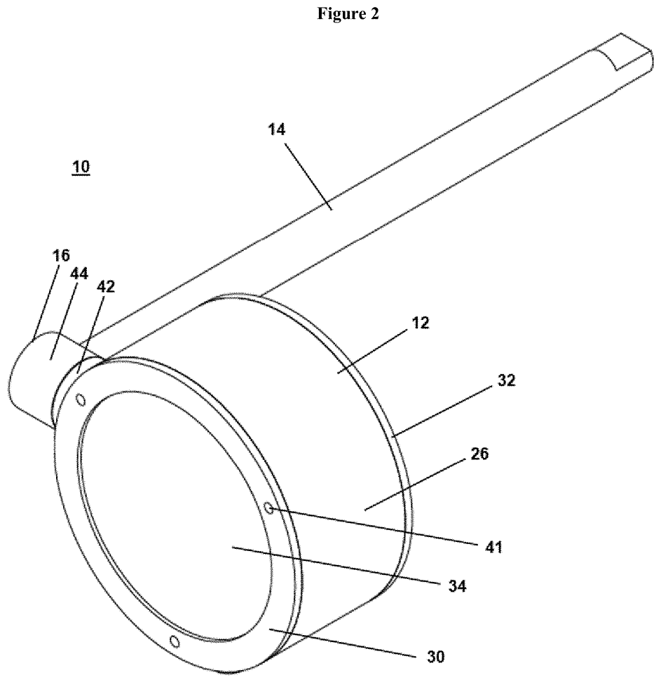

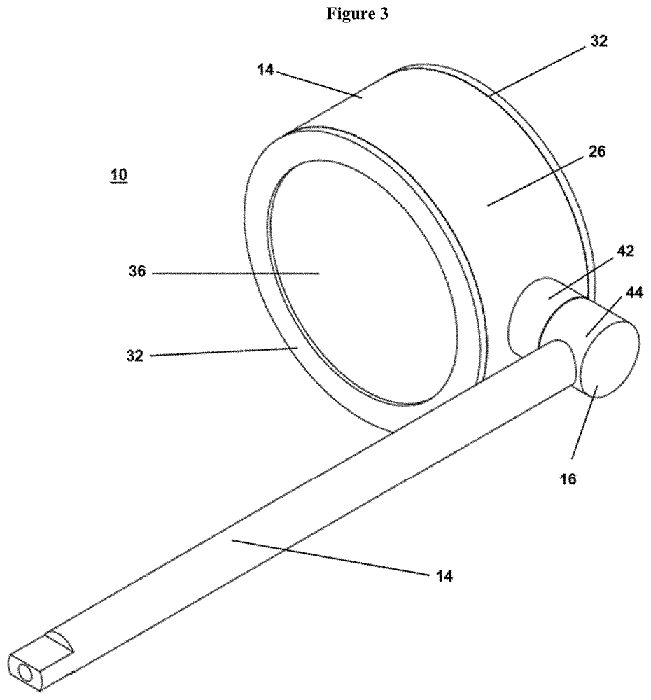

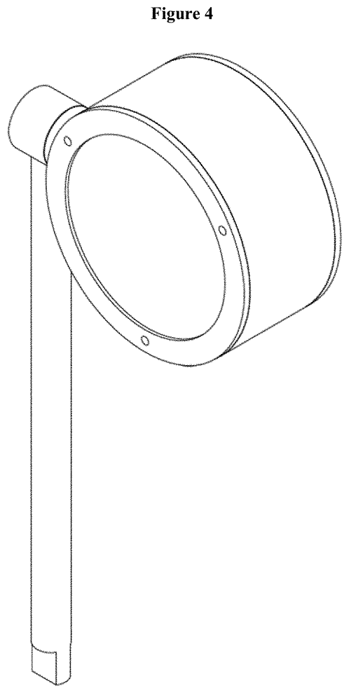

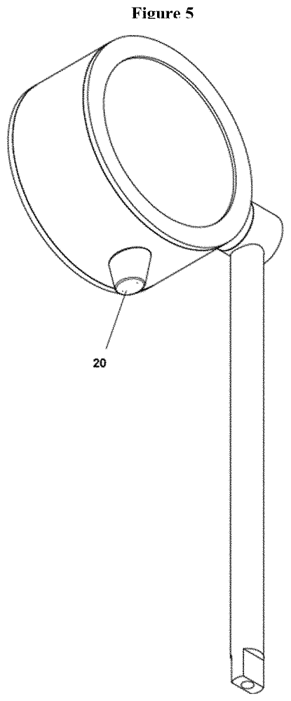

An exemplary display will now be described in reference to the drawings. FIGS. 1-5 shows a display 10, comprising a body 12. The body 12 is mounted on an arm 14 through a knuckle 16. The body 12 is freely rotatable in either direction as shown in FIG. 1 about a central axis via the knuckle 16. The arm 14 cantilevers the body 12 and extends the body 12 from a mounting surface such as a wall or table. The body 12 is weighted so that it returns to a desired starting position once a user releases the body 12 after rotation.

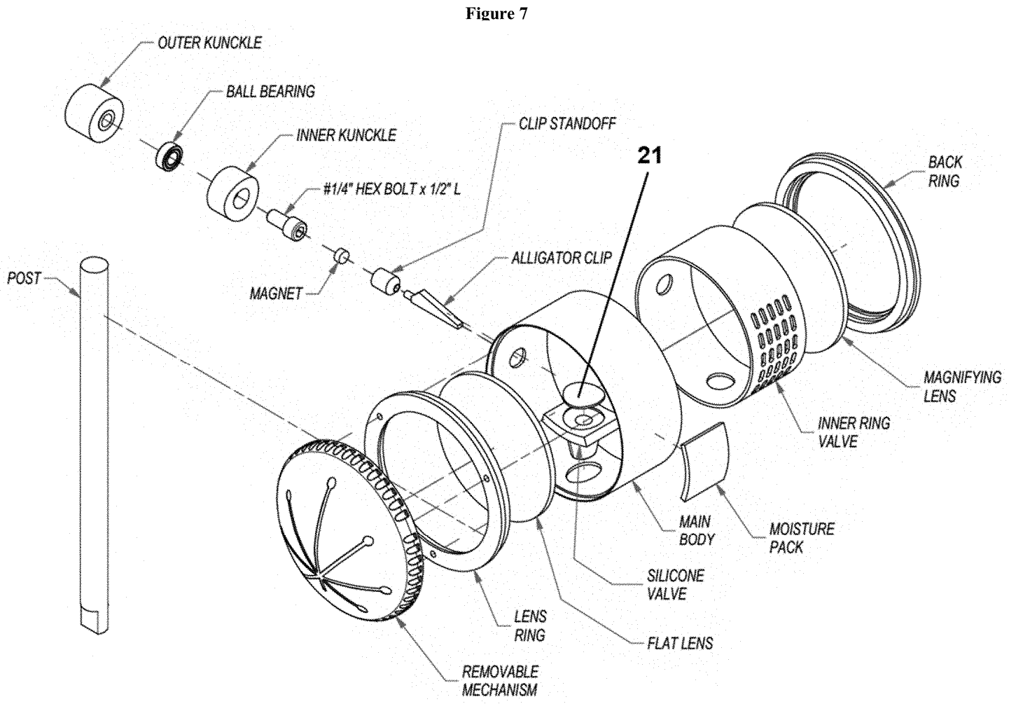

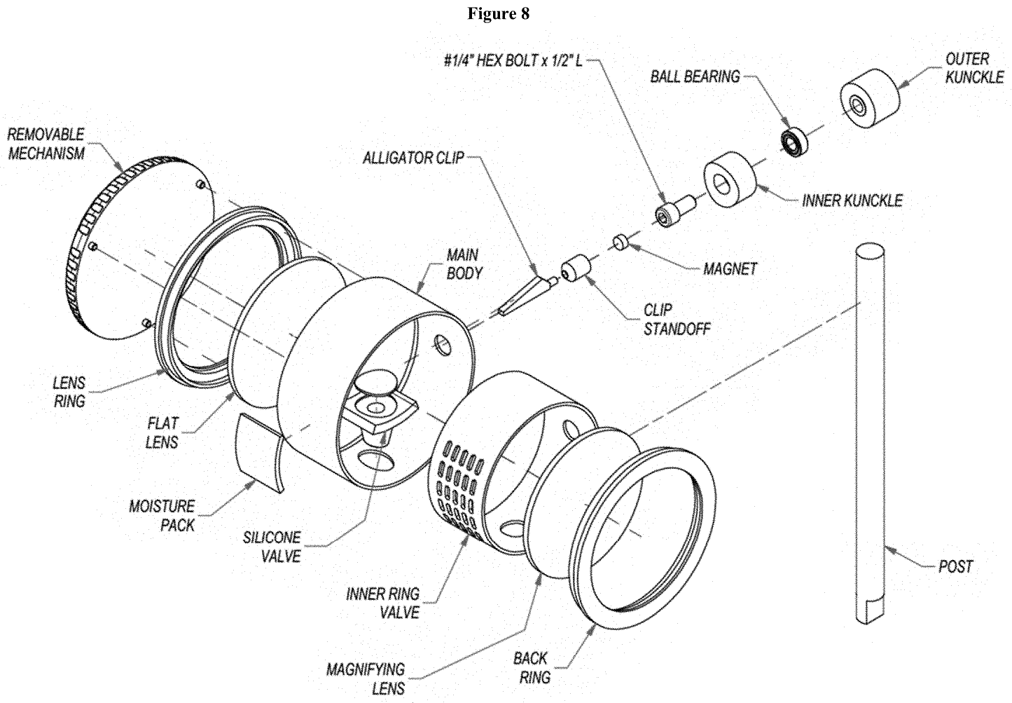

The body 12 comprises a scent port 18 that comprises a scent valve 20. The scent valve 20 is pinchable or squeezable so as to permit airflow between the interior of the body 12 and the outside environment, thereby allowing a user to smell an aromatic product 22. In the case of FIG. 1, the product 22 is Cannabis or hemp but it will be understood that any desired product may be displayed in the body 12 described herein. The scent valve 20 contains an optional screen 21 as shown in FIGS. 7 and 8, which may be of any desired mesh in order to prevent particulate matter or small products from falling through the scent port 18. Typically, the screen 21 is of fine mesh.

The body 12 further comprises an inner wall 24 and an outer wall 26, which collectively define a gap therebetween. The inner wall 24 comprises a plurality of apertures 28 that are in fluid communication with the interior space of the body 12. The gap between the inner wall 24 and the outer wall 26 is sized to house a moisture pack that controls the environment within the interior of the body 12. Instead of a pre-formed moisture pack, moisture particles, beads, or granules may be provided in the gap. Such moisture packs provide a desired level of humidity to the enclosed product and can be selected to absorb moisture from the air or to provide a chosen percent level of humidity, depending upon the chosen product for the display.

To this regard, the body 12, which is substantially cylindrical and formed from a circumferential wall, is substantially sealed from the outside environment through use of a first cover 30 and a second cover 32, respectively comprising a first window 34 and a second window 36 for viewing the enclosed product 22. In the illustrated embodiment, the first window 34 is a normal lens with no magnification and the second window 36 is a magnifying lens for closer inspection of the enclosed product 22.

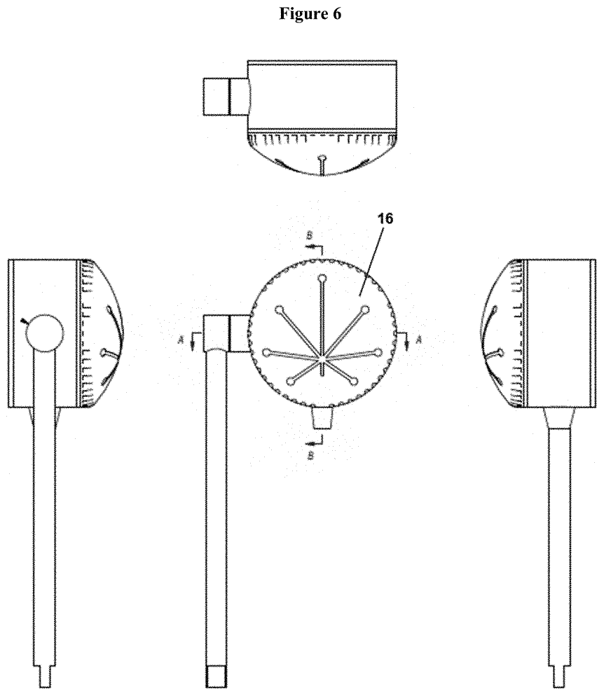

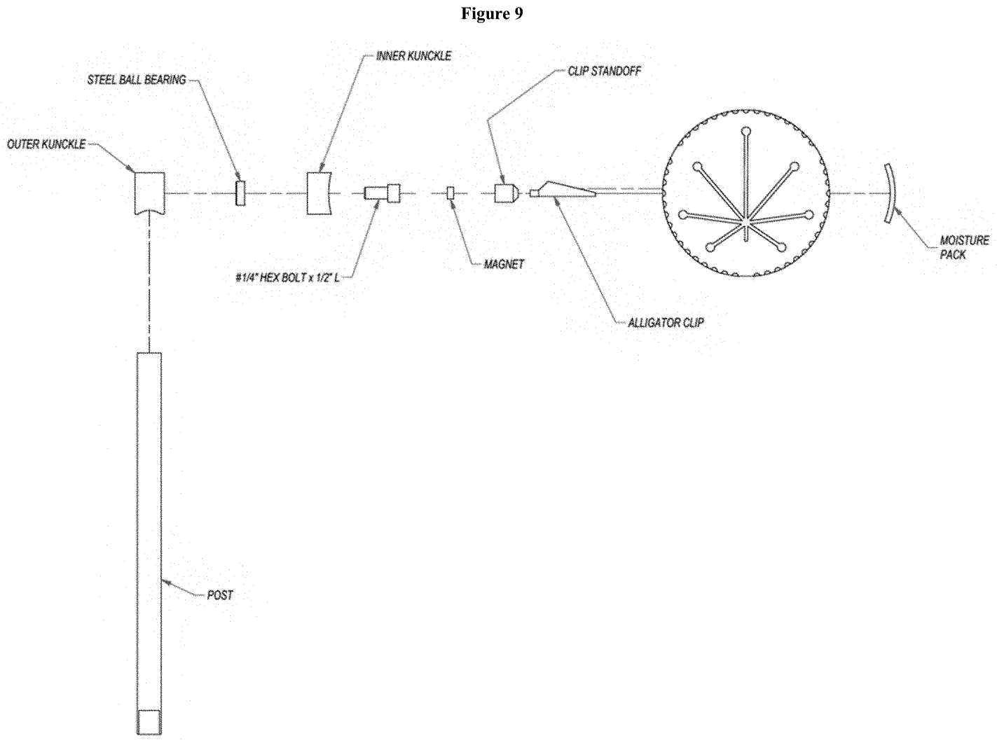

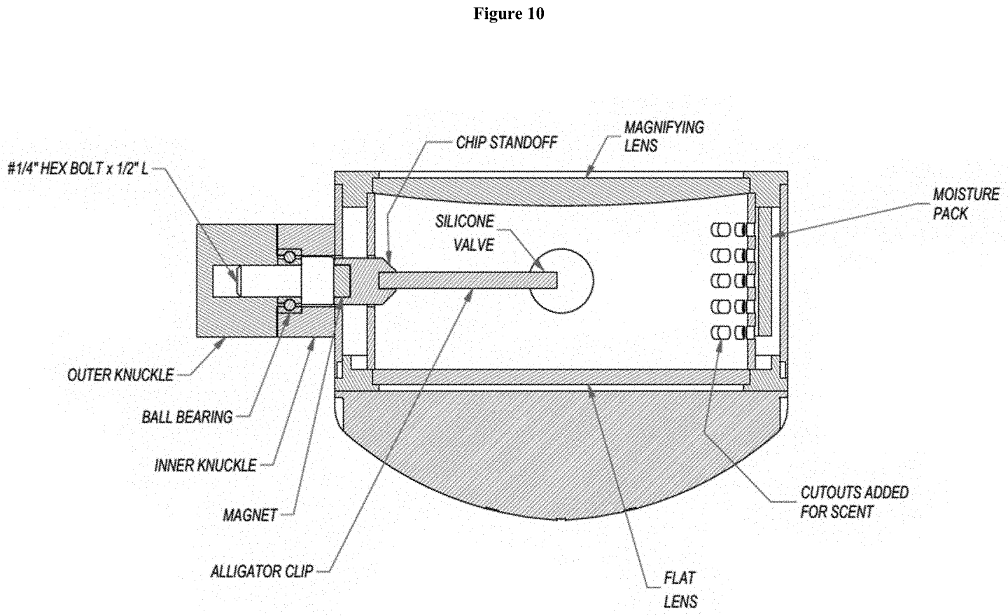

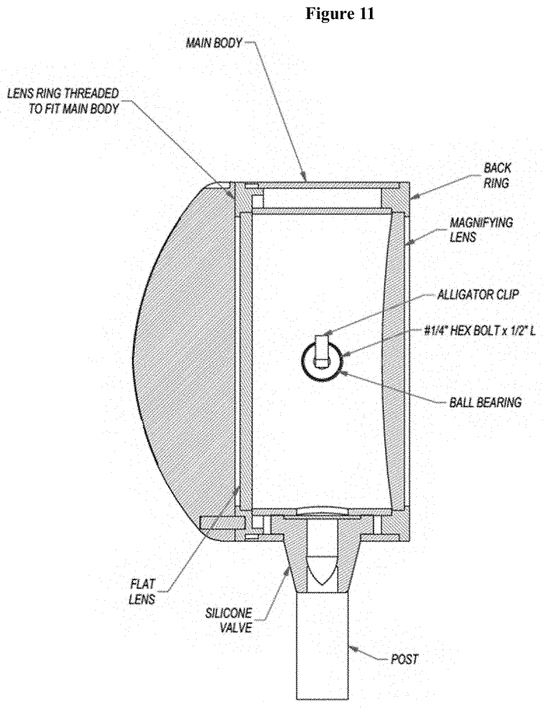

Turning now to FIG. 6, front and side views of the device 10 are shown, with a key 38 engaged on the first cover 30 through matching extension 39 on the key 38 and indentations 41 on the first cover 30. FIGS. 7, 8, and 9 show exploded views of the construction of the display 10 and FIGS. 10 and 11 are cross-sectional views of the body 12 along lines A-A and B-B of FIG. 6, respectively. These figures show how the inner wall 24, outer wall 26, first and second covers 30, 32, respective windows/lenses 34, 36, and key 38, along with the scent valve 20 and moisture pack 40 all fit together. Further shown, are the components of the knuckle 16, including an inner knuckle 42, ball bearing 44, and magnetic support 46. The support 46 extends through apertures defined in the inner and outer walls 24, 26 in order to hold the enclosed product within the body 12 of the device 10.

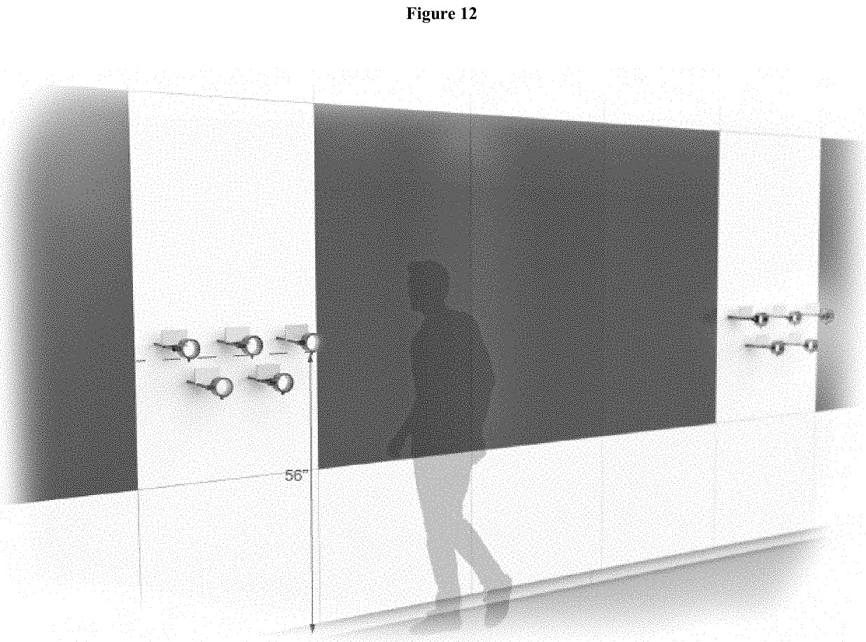

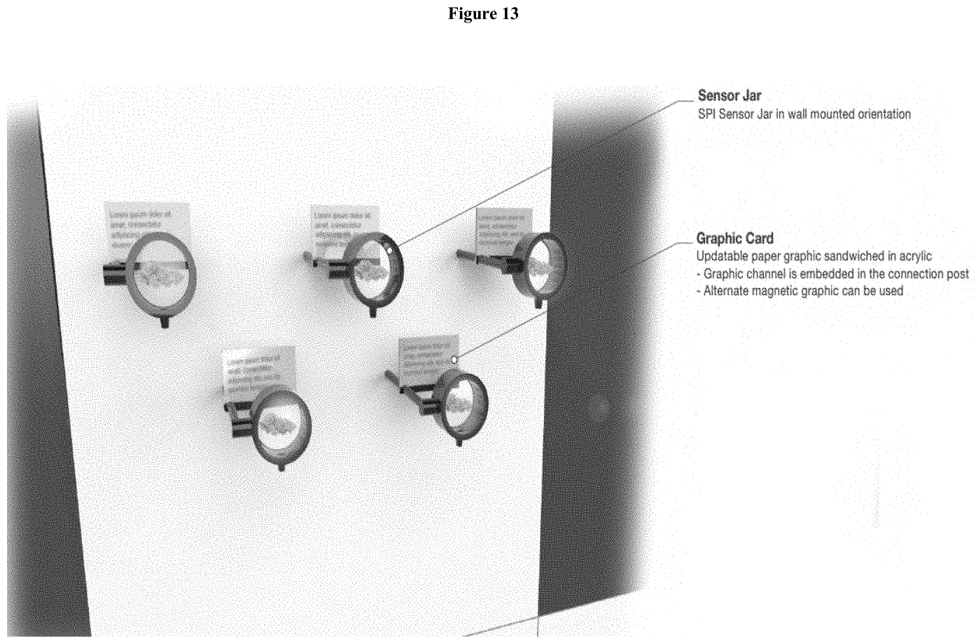

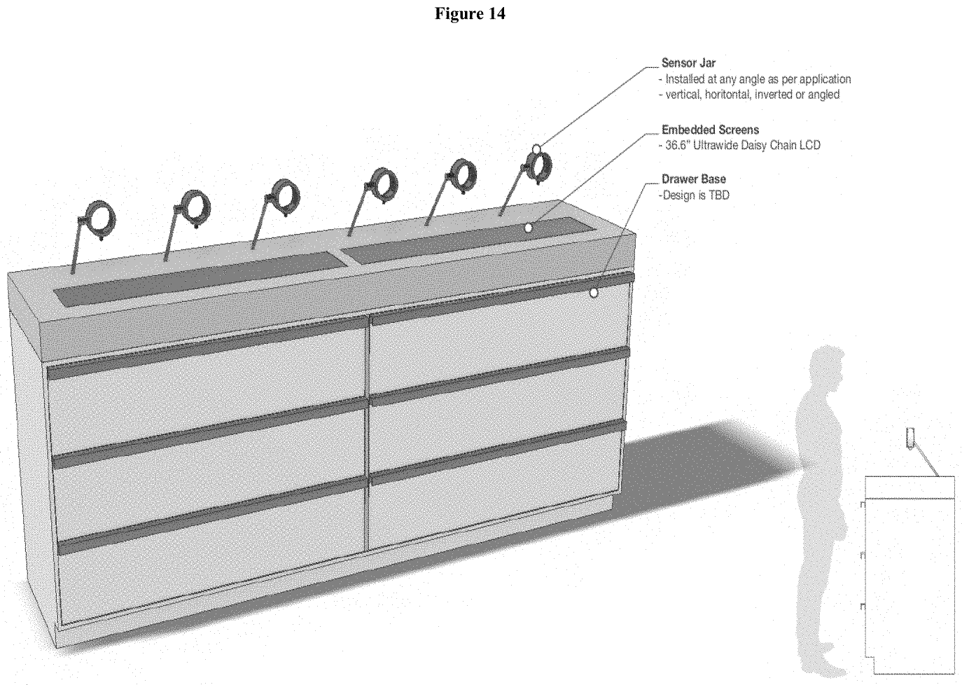

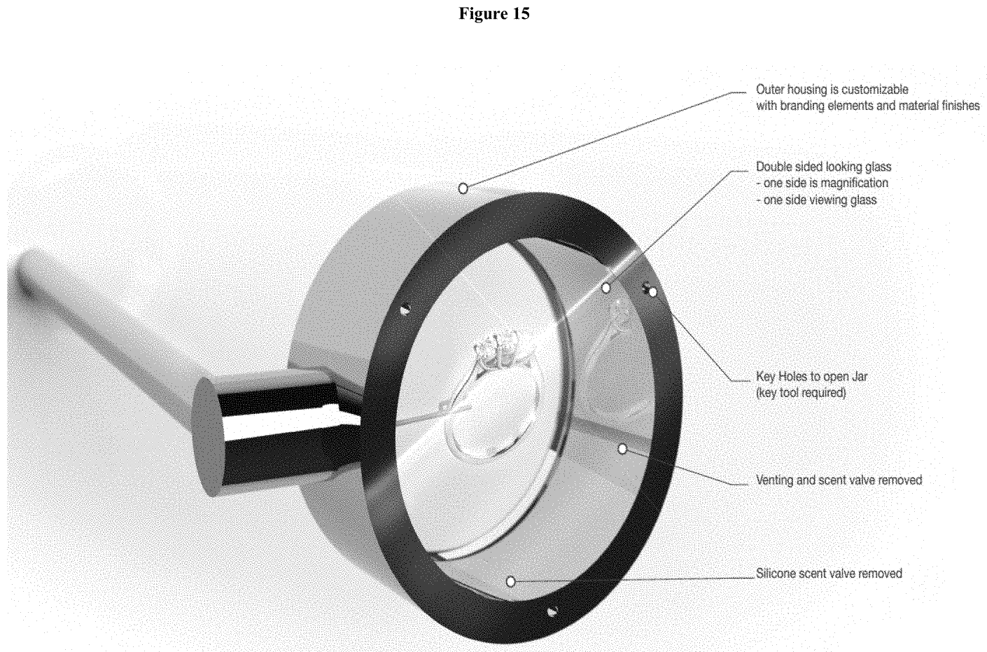

FIGS. 12, 13, and 14 show how the display may look in a shop with a product on display. In aspects, the device is touch responsive and a screen near the device is activated upon being touched by a user. It can be easily understood from these figures that the display 10 is inviting to a user and encourages the user to use his or her senses to assess the product 22, while keeping the product 22 out of the physical reach of the user. This is advantageous for products that are easily stolen or tampered with, or products for which there are strict handling rules in place, such as is the case for Cannabis. Finally, FIG. 15 shows the display 10 holding a piece of jewelry, in this case a ring. In this case, the display 10 is still rotatable, however, the apertures 28 in the inner wall 24 and the scent port and valve 18, 20 have been removed.

While the body 12 has been described as being substantially cylindrical, it will be understood that any desired shape is contemplated herein. For example, the body may be spherical, square, cubical, irregular, trapezoidal, conical, and any other desired configuration that permits sensory assessment of an enclosed product. Likewise, the body may be formed from a contiguous circumferential wall, as shown, or it may be formed from various connected walls with sharp and/or smooth corners and/or edges.

Similarly, while transparent windows are shown in the above-described embodiments, it will be understood that the body could be completely transparent or be made of a material that is transparent in one or more desired regions. On the other hand, the body may be completely or partially translucent or opaque. For example, if the product to be enclosed in the body is best assessed by a user through scent, in some aspects it may be desired to make the body completely opaque so that sensory assessment of the product is by scent alone. Of course, as shown in the drawings described above, combinations of transparent, translucent, and/or opaque regions are typical. Any transparent regions or windows may have no magnification or they may magnify or reduce the enclosed product to any desired degree, and combinations of no magnification, magnification to one or more same or different degrees, and reduction to one or more same or different degrees are contemplated herein.

The display has been shown with a single cantilevered arm. While this may be typical and aesthetically pleasing, it will be understood that any desired configuration is contemplated that provides rotation and/or access to the user to a scent valve. For example, two arms, one on each side of the body, may be used. In embodiments where the display is not necessarily rotatable, it may be desirable to omit the arm and/or knuckle entirely and simply set the body on a surface. Moreover, the knuckle is not necessarily required, as the body could be engaged directly to the arm, rotatably or not, in which case the body would extend in the same axis as the arm rather than extending away from the arm via the knuckle.

In embodiments where the body is rotatable, an axis of rotation will be provided that needs not be central. Providing an off-centered axis of rotation may be used in order to encourage the body to have a preferred resting position without needing to include a weight or counterbalance for example. Further, the rotation may be unidirectional or bidirectional as desired.

The scent valve has been described above as being a squeeze valve. While this is typical, any other form of sealable valve is contemplated. For example, the scent valve may be a pinch valve and/or may use as lever, button, or knob for example to open and/or close the scent port. The scent valve may be, for example, a gravity valve that is held in a closed position in one orientation and an open position in another orientation. Typically, the scent valve is made of a resilient material such as silicone, but it may be made of any desired material depending on the type of valve chosen. It will be understood that a substantially airtight environment may be desirable for certain enclosed products, such as those of plant matter that may be susceptible to overdrying on one hand or mold and/or degradation on the other hand.

The key described above has been shown as being substantially circular to match the shape of the first window. The key may be of any desired shape, matching the body or not. The key need not have multiple extension matching multiple indentations on the first cover or body. Instead, it could be involve a simple keyhole on the body and a corresponding key that, when engaged, permit the opening of the body. Moreover, the extensions may instead be on the body, with corresponding indentations on the key, for example. It is contemplated that one key may be used to open both the first and second covers, or there may be two different keys, one for each cover, or in other aspects, only one cover may be openable with or without a key.

The body has been described above as comprising a double wall, made of an inner wall and an outer wall that together provide a space or gap between the two walls, such that the wall is hollow. It will be understood that the wall may be entirely hollow or partially hollow, or entirely solid. Where humidity is desired to be controlled, it is not necessary that moisture packs or the like be provided in the hollow spaces or gaps between the walls. Instead, a port may be provided on a wall of the body, optionally through the knuckle, that provides humidity control through moisture packs or the like or even through a conduit that is connected to a humidifier or de-humidifier for example, as desired.

In aspects, the display or any part thereof is formed from plastic, metal, wood, glass, combinations thereof, or any other desired material. Optionally, the display or any part thereof is electrically connected to a screen, which is typically close by or a part of the display. The display itself may be electrically conductive, such that a user touching the display or any part thereof results in the screen displaying product information, for example. Alternatively or additionally, there may be, for example, a button or lever that a user can press in order to activate the screen. When a plurality of displays are provided together with one or more screens, touching any given display or a button or lever associated therewith may active one or all of the screens or any combination thereof. The screens may also be activated by motion instead of touch or any other known method of activation when a user approaches a display as described herein.

The support for holding the product within the body has been described as being magnetic. It will be understood that while a removable magnetic support may be typical, it is contemplated that the support may snap into place, fit with friction, and may or may not be removable. The support may be an alligator clip, a fixture arm, or it may comprise a plurality of supports that collectively hold the desired product in place. For example, one or more wires or strings may extend from different regions of the interior of the body to collectively hold the product in a desired position.

### Methods of Use

In use, the display 10 is assembled as shown in the figures and as described above. A desired product 22 is inserted into the body 12 of the display 10, typically on the support 46 included therein. As the support 46 is magnetically engaged to the knuckle 16, it is a relatively simple exercise to attach the product 22 to the support 46 and insert the support into the body 12. Once in place, the inner and outer walls 24, 26 are put into place using the optional key 38. The arm 14 can be mounted on any desired surface, such as a table, wall, floor, or ceiling, and then a user can enjoy sensing attributes associated with the product 22, such as smelling the product 22 and examining the product 22 optionally under magnification. Upon smelling the product through the scent valve, the valve automatically reseals into a closed position in order to revert to a substantially airtight configuration. Due to the structure of the display 10, the user is not easily able to physically touch the product 22, however, this does not prevent the user from assessing the product using sight and/or smell.

The above disclosure generally describes the present invention. Changes in form and substitution of equivalents are contemplated as circumstances may suggest or render expedient. Although specific terms have been employed herein, such terms are intended in a descriptive sense and not for purposes of limitation.

All publications, patents, and patent applications cited above are herein incorporated by reference in their entirety to the same extent as if each individual publication, patent or patent application was specifically and individually indicated to be incorporated by reference in its entirety.

Although preferred aspects of the invention have been described herein in detail, it will be understood by those skilled in the art that variations may be made thereto without departing from the spirit of the invention or the scope of the appended claims.

1. A sensory display comprising a rotatable body for enclosing a product.

2. The display of claim 1, wherein the product is isolated from being touched by a user.

3. The display of claim 1, wherein the body comprises a scent port for smelling the product.

4. The display of claim 3, wherein the scent port comprises a screen, optionally of fine mesh.

5. The display of claim 3, wherein the scent port comprises a scent valve.

6. The display of claim 5, wherein the scent valve is a gravity valve or a squeeze valve squeezable from a closed position to an open position, wherein the squeeze valve is biased to the closed position, wherein the closed position is substantially airtight.

7.-9. (canceled)

10. The display of claim 5, wherein the body is substantially cylindrical and comprises a circumferential wall, the circumferential wall comprising a first end and a second end defining an interior space therebetween, the display further comprising a first cover for enclosing the first end of the circumferential wall, wherein the first cover comprises a first window that optionally magnifies the product.

11.-14. (canceled)

15. The display of claim 10, further comprising a second cover for enclosing the second end of the circumferential wall, wherein the second cover comprises a second window that optionally magnifies the product.

16.-18. (canceled)

19. The display of claim 15, wherein the first and/or second cover lockably engages the respective first and or second end of the circumferential wall.

20. The display of claim 15, further comprising one or more keys for engaging with and removing the first and/or second cover, wherein the key comprises one or more protrusions that engage with indentations on the first and/or second cover.

21. (canceled)

22. (canceled)

23.-24. (canceled)

25. The display of claim 22, wherein the inner wall comprises one or more apertures providing fluid communication between the gap and the interior space, and further comprising a moisture-controlling component such as a moisture pack in the gap.

26. (canceled)

27. The display of claim 1, further comprising a knuckle for supporting the body for rotation, wherein the knuckle comprises an inner knuckle and an outer knuckle, rotatably engaged to one another.

28. (canceled)

29. The display of claim 1, further comprising an arm for supporting the body on a surface, such as a table or wall, wherein the body is cantilevered with respect to the arm.

30. (canceled)

31. The display of claim 1, wherein the body comprises an interior support for mounting the product, wherein the support remains stationary when the body is rotated or wherein the support rotates together with or independently of the body.

32.-33. (canceled)

34. The display of claim 31, wherein the support extends through the circumferential wall and engages the knuckle.

35. The display of claim 31, wherein the support comprises a clip.

36. The display of claim 1, wherein the body protects the product from tampering and/or theft.

37. (canceled)

38. The display of claim 1, wherein the body provides a humidity controlled environment for the product.

39. (canceled)

40. The display of claim 1, wherein the body is weighted and/or supported so as automatically to return to a desired position after rotation.

41.-54. (canceled)
